(19) United States
(12) Patent Application Publication
(10) Pub. No.: US 2003/0208360 A1
(43) Pub. Date: Nov. 6, 2003

(54) Fund raising method

(76) Inventor: Jeffrey J. Kaas, West Allis, WI (US)

Correspondence Address: JOSEPH S. HEINO, ESQ., DAVIS & KUELTHAU, S.C., 111 E. KILBOURN, SUITE 1400, MILWAUKEE, WI, 53202-6613, US

(21) Appl. No.: 10/136,013

(22) Filed: May 1, 2002

(51) Int. Cl. G06F 17/60

(52) U.S. Cl. 705/1

(57) ABSTRACT

A fund raising method is provided whereby an independent contractor contacts, or is contacted by, a fund raising customer. The independent contractor thereafter provides initial information to the customer. The fund raising company provides an informational pamphlet to the customer that includes sample products, catalogs and a complete description of the program. The customer distributes the information to others who buy products from the program. The orders are tallied and entered into the central computer and processed by the fund raising company. The fund raising company then issues a credit towards end products for a substantial portion of the entire amount, if not the entire amount, of the order. The fund raising company tracks the performance of the independent contractors. The customer may then order end products from the company. These orders are also processed through the fund raising company and end products are delivered to the customer.

### FIELD OF THE INVENTION

This invention relates generally to methods of fund raising and to methods for realizing a return for the sale of a fund raising product. More particularly, it relates to a method of fund raising that includes providing merchandise or end products in the form of books or other commodities that are desired by a customer, which end products are purchased by a fund raising company in high volume. It also particularly relates to such a method whereby those end products are provided to customers, such as child care facilities, at prices below that which the customer could ordinarily find in an equal exchange for the selling of a fund raising product.

### BACKGROUND OF THE INVENTION

The concept of soliciting donations of money for worthwhile causes has long been an accepted method of fund raising for charitable and other nonprofit organizations. In fact, such organizations rely, in large part, on those very donations for their continued existence. In the most simplistic form, donations of money are solicited by volunteers who donate their time going door to door with collection cans, by standing on street corners with collection pots during holiday seasons and even by conducting telethons and the like. These volunteers, and the persons who donate to them, do what they do because of the worthwhile nature of the very cause that is the recipient of the donations. These simple fund raising methods are successful, but only to the point that the individuals who donate to them truly believe in the cause or are moved by the spirit of giving for whatever reason. For small self-promoting and self sufficient organizations, such as daycare and child care facilities, such fund raising methods simply may not work.

A slightly more sophisticated method common among fund raising organizations utilizes the sale of some item that has some intrinsic value, but which is sold by the organization at a price that somewhat exceeds that value. In this method, the individual who donates feels somewhat gratified that he or she has actually received something in return for his or her donation. Selling cookies, candies, paper products, pizzas, etc. are typical examples of this method of fund raising. A major drawback to this method of fund raising is the cost of operation which, in the experience of this inventor, can be as much as 50 to 60% of the funds raised. The organization raising funds through this method generally receives only 40 to 50% of the total dollars raised.

In the experience of the inventor, no other methods of raising funds heretofore conceived and implemented have sought to return 100% of the amount raised to the organization attempting to raise money. Accordingly, and as will become apparent by this disclosure, the method of the present invention seeks to provide a much higher rate of return than traditional methods. Upon implementation, the method of the present invention actually realizes that higher rate of return, approaching 100% return. This, in the view of this inventor, is unprecedented.

### SUMMARY OF THE INVENTION

In the experience of the inventor, one of the most important considerations from the viewpoint of the persons who are being solicited for donations is the manner in which they are asked to give money. Stated another way, in order for a fundraiser to be successful, an inventive and innovative concept is essential.

One of the most significant aspects of a successful fundraising event is the training of the organizers and operators of the fundraiser. To that end, the present invention provides for a systematized, detailed training of the independent contractors who coordinate activities with customers who, for example in the case of childcare or daycare facilities, wish to increase the contents of their libraries.

Also in the experience of the inventor, the preferred method of fund raising relies upon the regular and systematic collection and accumulation of donated funds. To this end, the preferred method of the present invention also involves a detailed program, or start up package, to help the customer get the fundraising program up and running with very little, if any, initial expense.

In the experience of the inventor, childcare and daycare facilities are often small organizations that generally have very limited financial resources. Also in the experience of the inventor, many of the products necessary for the success of a daycare or childcare facility, such as books and educational supplies, can be purchased in bulk at a significant discount. It is these childcare and daycare facilities that can greatly benefit by the method of the present invention.

Accordingly, it is an object of the present invention to provide a new and useful fund raising method whereby costs are minimized and an incentive is afforded to the organizations seeking donations. It is another object of this invention to provide a fund raising method whereby up to 100% of the net amount of funds raised is returned to the organization in the form of desired merchandise. It is yet another object of the present invention to return the amount of funds raised by the organization back to the organization in the form of merchandise that is beneficial to that organization. It is yet another object of the present invention to provide a method for training for the independent contractors who market the fundraising method to such organizations.

### BRIEF DESCRIPTION OF THE DRAWINGS

FIG. 1 is a block diagram illustrating the principal steps of an organization process that forms a component of the fund raising method embodied by the present invention.

FIG. 2 is a block diagram illustrating the steps of donation solicitation used by the independent contractors.

FIG. 3 is a block diagram illustrating the steps of donation made by individuals who participate in the program.

### DETAILED DESCRIPTION

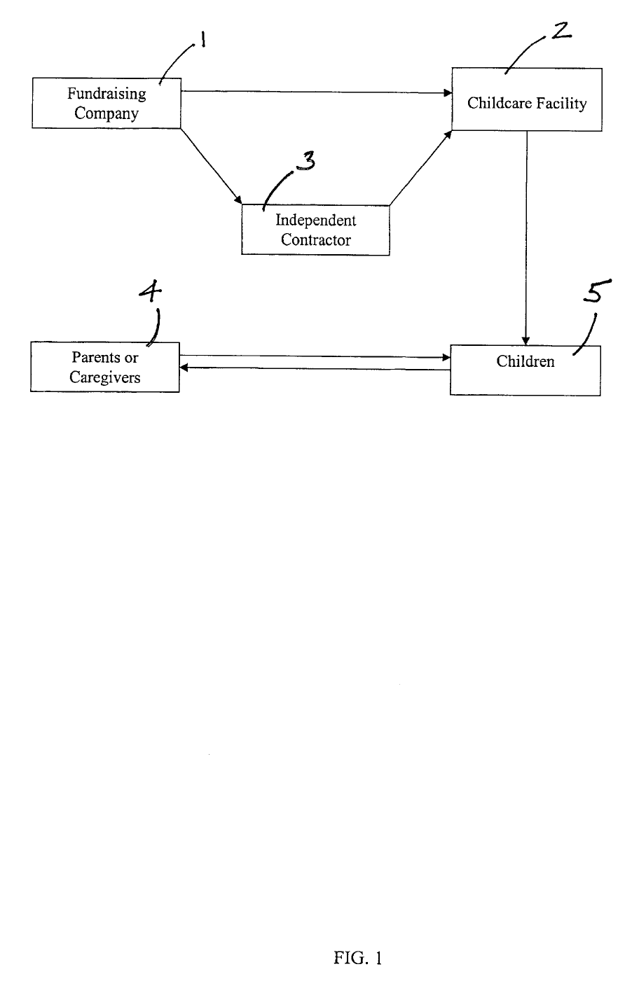

Referring now to the drawings in detail, wherein like numbered elements refer to like elements throughout, FIG. 1 illustrates a schematic overview of the fundraising process. Throughout this detailed description, the method of the present invention has been described as it is applied to a childcare facility, a preferred application of the method. While it is helpful to examine the method of the present invention in the context of a child care facility, it is to be understood that the method of the present invention could be applied to nearly any organization selling any kind of product. Additionally, the end product or merchandise provided to the fund raising customer could be any type of product desired by that customer. In other words, the example given should be interpreted as illustrative and not as a limitation of the method of the present invention.

In its most basic form, any sort of fundraising activity that one would wish to use so as to generate a positive outcome must have a certain appeal. In this particular instance, virtually every adult desires that his or her child have access to books. Books have been, and still are, a media from which young children can learn much about themselves and the world around them. The embodiment of the invention as set forth in this detailed description could be named a “literacy program” or “literacy project.”

In general, the method of the present invention may provide for a catalog of seasonal decorations and supplies or other novelty items to be distributed among the parents 4 of children 5 attending a childcare facility 2. Each purchase of such decorations or supplies generated from the program is then credited to the childcare facility 2 for the purchase of a matching value in books or other literary works. Given such large volume of books to be purchased, the fundraising company 1 that is operating the method of the present invention is able to purchase the books at a bulk discount.

As is shown in FIG. 1, this process is highly dependent upon the active participation of the parents or caregivers 4 of children 5 at the childcare facility 2. For example, a fairly large facility 2, with one hundred children 5 in its care, may receive one $5.00 order for decorations or supplies from each parent or guardian 4 for a total of $500. The childcare facility 2 is then eligible to receive a matching $500 in the form of a credit to be applied to books for the facility 2. In this fashion, even with relatively modest orders, a childcare facility 2 may rapidly expand its library of new books each time a fundraising drive of this type is held.

Obviously, part of the strategy for raising money involves targeting an audience that will be interested in the program. This particular program is focused on increasing children's 5 access to books and educational supplies in the day care setting 2. Therefore, those particularly interested in such programs are both childcare providers 2 and the parents 4 of children 5 in childcare facilities 2.

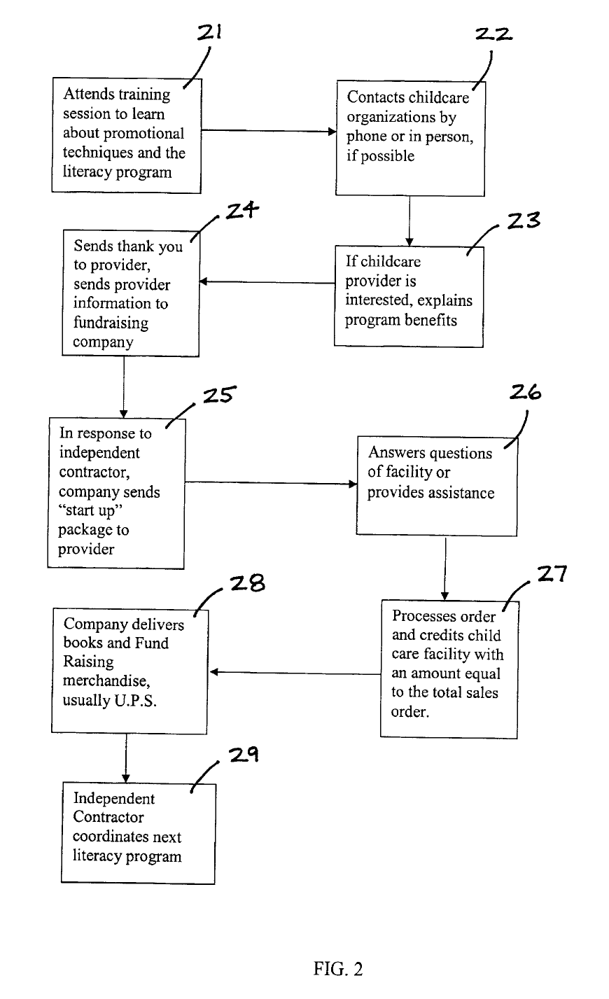

In this regard, however, the present invention provides for a facilitator, or independent contractor 3, who is specially trained by attending training sessions sponsored by the fundraising company to maximize the fundraising efforts and thus maximize the return to the fundraising company 1 and to the children 5 and facility 2. See FIG. 2. These independent contractors 3 are trained 21 to market the method of the present invention to childcare centers 2. Obviously, information about childcare centers 2 is readily available through any number of resources, including the internet, the Yellow Pages, and word of mouth.

Once properly trained, the independent contractor 3 contacts 22 the childcare center 2. The purpose of the contact 22 is to generate interest in the literacy program. During the contact 22, the independent contractor 3 introduces the program. The independent contractor 3 should also promote the notion that the program provides a simple and essentially “free” way for the provider 2 to build a library of new books virtually without any investment. If the contact, the childcare facility 2, is interested, the independent contractor 3 continues to explain 23 how the method works. In a contact scenario, for example, the independent contractor 3 might explain that all money generated through selling a product, normally a seasonal decoration, will be totaled. The childcare center 2 will then be granted a credit equal to the amount totaled to be used for books and educational supplies, i.e. the end products.

If the childcare facility 2 desires to participate in the program, the independent contractor 3 next contacts 24 the fundraising company 1 and sends them the provider's name, address and the number of potential participants in the program. The independent contractor 3 also sends 24 the provider 2 a post card thanking it for participating in the literacy program and perhaps providing some encouragement for the program itself. For example, testimonials may be used, as people are often encouraged when they hear about how the program has worked for other people as opposed to just hearing the independent contractor's assurances.

The next step is carried out by the fund raising company 1. Using the information provided by the independent contractor 3, the company 1 sends 25 a “start up” package to the childcare facility 2. The “start up” package includes a note thanking it for participating in the program, a sheet outlining the steps necessary for a successful program, a copy of the worksheet filled out by the independent contractor 3, a letter to the parent or parents 4 of each child in the program, the number of fundraising fliers requested by the facility 2, an address sheet identifying the facility 2 and a return envelope so that all that the facility 2 needs to do is concentrate on encouraging parents 4 to participate in the program.

After the facility 2 has received the fundraising package, the facility 2 will normally have questions for the independent contractor 3. For this reason, the method of the present invention provides for the independent contractor 3 making a follow-up call or visit to the day care to answer 26 any question the facility 2 might have and to provide any encouragement the facility 2 might need.

At this point, the facility 2 has all of the tools and information in place to employ the method of the present invention. If any questions or problems arise, the independent contractor 3 is available 26 as a representative of the fundraising company 1. At the conclusion of the program, the facility 2 tallies the amount of product sold and writes a check to the company 1. At the same time, the facility 1 chooses from the array of books and educational supplies that are offered by the company 1. The method of the present invention then provides that the order is processed immediately 27. The childcare facility 2 sends orders and one check for the entire amount raised to the fund raising company 1. The company 1 processes the order from the facility 2 and ships the fund raising merchandise and earned products, in this case books, to the facility 2, usually by UPS. The independent contractor 3 coordinates a program for the following year 29.

Even the unique and timely method of fundraising outlined above will fail to generate a positive outcome without the necessary people to implement the program. As alluded to earlier, the method of the present invention provides a comprehensive program for training people 21 who wish to participate in the program. Generally, people interested in participating in the program are given the status of independent contractors. The independent contractor 3 is really the backbone of this method. The independent contractors 3 are required to attend training and educational 21 sessions including, but not limited to, telephone etiquette and courtesy, sales procedure, marketing procedure, internal company procedure and updates in production information and product availability. It is essential that the independent contractor 3 be both knowledgeable and helpful.

Extensive use of multimedia is present in the training program to save cost and allow the independent contractors 3 a flexible approach to their training. Therefore, educational presentations regarding this training material have been recorded using digital technology. Prospective independent contractors 3 can listen at their leisure and study the more traditional print media accompanying the digital information. In this manner, the fundraising organization is able to communicate a complex training scheme without unduly burdening the prospective independent contractor 3 with hours and hours of reading.

Along with using digital technology, the fund raising company 1 provides each independent contractor 3 with four training manuals. Each manual explains in detail the material that makes up the method of this invention. The independent contractor 3 signs a legal document acknowledging receipt of these manuals and his or her understanding that their contents outline the method of this invention. All of the material is considered trade secrets and are not to be shared with anyone outside of the company 1. The independent contractor 3 signs to acknowledge that all of the materials are the company's property, that they will not be copied and will be returned complete to the company 1 upon termination of the relationship. Due to the unique process of this method, each independent contractor will also acknowledge that all customers are customers of the company 1, and that the independent contractor cannot, either on his or her own or as an employee, be part of a competitive company during the relationship or thereafter.

The fund raising company 1 will also use a web site on the world wide web to educate and inform both the independent contractor 3 and the childcare facility 2 about this method. The web site will explain how the method works to a prospective group that may be curious about participating. The materials on the site will, however, be proprietary to the fund raising company 1 and are to be used in activities operated only by the company 1.

The method of the present invention also provides for an internal incentive program for independent contractors 3. For example, an incentive could be a prize for the independent contractor 3 who secures the most contracts, for all independent contractors 3 who secure a minimum number of contracts, or for the independent contractor 3 who experiences the fewest cancelled contracts. The internal incentives possible are many and only limited by the imagination of the company involved. External incentives are also possible. For example, an independent contractor 3 could solicit goods or services from corporate sponsors and use the goods or services to award people who buy more product or, again an internal incentive, to award independent contractors 3.

The method of the present invention provides for a fund raising company 1 to be the centralized clearinghouse for sales generated by the independent contractors 3. The method of the present invention provides for a complete accounting program to process orders and payments online. Independent contractors 3 can then access their personal accounts via computer, submit orders and view payments. In this manner, orders submitted to the fund raising company 1 can be immediately processed and the books and merchandise mailed to the childcare facility 2. The computer can also be used to track sales statistics including deliveries and commissions. As the fund raising company 1 receives money and orders, the transactions are entered into the central computer system for tracking.

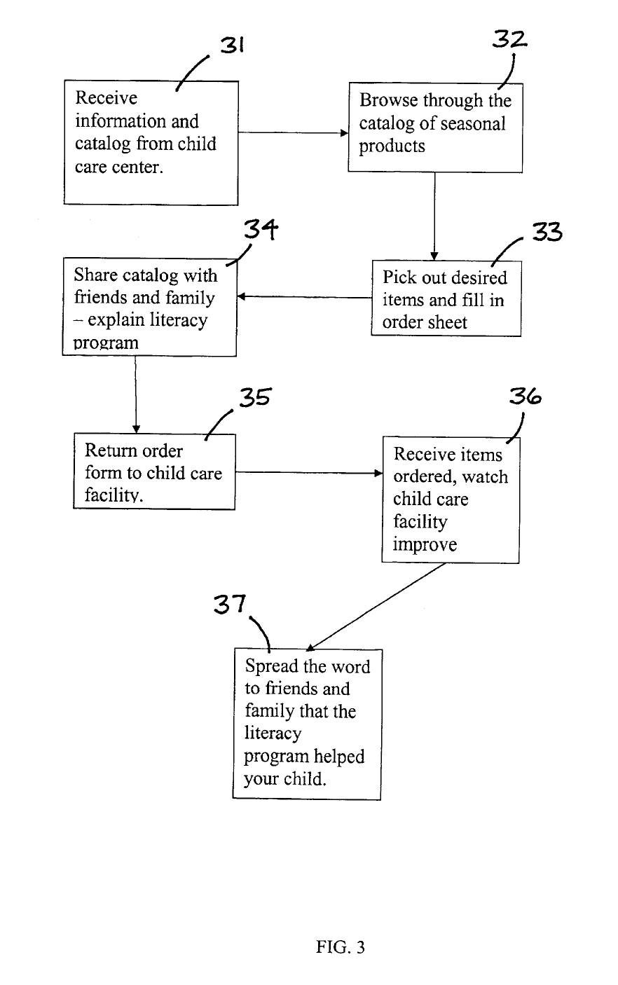

Any description of an invention of this type would be incomplete without a description of the experience of the targeted donor, the parents or guardians 4 of children 5 attending the childcare facility 2. The parents' 4 first exposure to the method of the present invention may be through a brochure or catalog strategically left in a prominent area of the childcare facility 2. It may also be when their child 5 first comes home with an informational packet and sales catalog 31. See FIG. 3. All the parents need do is browse through the catalog 32, which is normally comprised of seasonal decorations or delicacies, pick out items they desire 33, share the catalog with friends and family 34 and return the order form to the child care facility 35. The parents 4 then simply wait to receive 36 the items they ordered, and spread 37 the word that the literacy program helped their child 5.

From the foregoing description of the illustrative embodiment of the invention set forth herein, it will be apparent that there has been provided a new and useful method of fund raising whereby an independent contractor contacts, or is contacted by, a childcare facility. The independent contractor thereafter provides initial information to the facility. Next, the fundraising company provides an informational pamphlet to the childcare facility that includes sample products, catalogs and a complete description of the program. Next, the childcare facility distributes the information to the parents of children attending the childcare facility. When the parents, friends or relatives of the children buy products from the program, the orders are tallied by the facility and entered into the central computer and processed by the fund raising company. The fund raising company then issues a credit towards books or other end products for 100% of the entire amount of the order. The fund raising company also tracks the performance of the independent contractors. The childcare facility may then order books or other supplies from the fund raising company. These orders are also processed through the fund raising company and books and educational supplies are mailed from a central warehouse.

The principles of this invention having been fully explained in connection with the foregoing, I hereby claim as my invention:

1. A fund raising method that allows a fund raising organization to provide end products to a customer, said end products having a value matching that of the fund raising products sold by the customer,
contacting the customer regarding a fund raising project,
providing a package of program materials relative to the project to the customer,
having the customer distribute the materials to the persons who will promote the fund raising project,
selling the fund raising products displayed in the materials to purchasers,
collecting the purchasers' money,
distributing the fund raising products ordered by the purchasers,
crediting the customer for 100% of an amount ordered by the purchasers, and
distributing end product in that amount to the customer.

2. The fund raising method of claim 1 including, prior to said customer contacting step, the step of providing an independent contractor wherein said customer contacting step is performed by the independent contractor.

3. The fund raising method of claim 2 including the step of providing accounting and record keeping services for the project wherein all accounting and record keeping is accomplished by a centralized computer and the independent contractors may remotely access the computer to input or view data.

4. The fund raising method of claim 2 including the step of providing the independent contractors with performance incentives.

5. The fund raising method of claim 1 wherein the package providing step includes providing catalogs, order sheets, instructions for completing the order sheets, information regarding how the program works and the benefits to the customer that the program will provide.

6. The fund raising method of claim 1 wherein the fund raising products sold are merchandise of any form, including seasonal decorations or delicacies.

7. The fund raising method of claim 1 wherein the end products distributed are merchandise of any form, including books or other educational products.

8. The fund raising method of claim 1 including the step of providing those who purchase fund raising products with a gift.

9. A fund raising method for promoting literacy at a childcare facility comprising the steps of
compiling items of interest to childcare facilities, including books and other educational products,
developing a catalog of fund raising products for sale,
hiring independent contractors,
contacting the childcare facility,
sending program materials to the childcare facility,
having the childcare facility distribute the program materials, including the product catalog, to parents and others interested in the welfare of children at the childcare facility,
recording orders for products,
having the independent contractors forward the orders from the parents to a central database for orders,
delivering the products ordered,
crediting the childcare facility an amount for products purchased, and
delivering the items to the childcare facility.

10. The fund raising method of claim 9 wherein the products contained in the catalog are of any form, but are often geared towards seasonal merchandise.

11. The fund raising method of claim 9 wherein the products contained in the catalog are in any form, but are often seasonal decorations or delicacies.

12. The fund raising method of claim 9 wherein the central database is a remotely accessible computer with an account for each independent contractor whereby each independent contractor can access and update his or her account and review payment status in a read-only format.

13. The fund raising method of claim 9 wherein the program materials sending step includes sending catalogs, order sheets, instructions for completing the order sheets, information regarding how the program works and the benefits to the child care facility that the program will provide.

14. The fund raising method of claim 9 including the step of contracting corporate sponsors to arrange gift donations of cash or kind to either independent contractors or the childcare facilities themselves.

15. The fund raising method of claim 9 wherein said childcare facility crediting step comprises matching the monetary amount of fund raising products sold with 100% of the value of end products delivered to the childcare facility.

16. A fund raising method for promoting literacy comprising the steps of
selecting an appropriate product for sale,
recruiting independent contractors,
providing a program for training the independent contractors,
instructing the independent contractors to contact customers to interest them in the literacy program,
supplying the customers with the materials including product information and product catalogs for selling product as a fund raiser,
collecting monies received from the sales of product,
granting the customer a credit for the amount of product sold,
providing a catalog of books and educational supplies for the customer to purchase,
taking the customer's order for book and supplies, and
shipping the books and supplies to the customer.

17. The fund raising method of claim 16 wherein said customer credit granting step comprises substantially matching with up to 100% the monetary amount of product sold with books and educational supplies having the same value.

18. The find raising method of claim 16 wherein the products sold are merchandise of any form, but often are seasonal decorations or delicacies.

19. The fund raising method of claim 16 wherein said training program providing step includes providing the independent contractors with multimedia training, including the use of digital technology as well as written manuals that instruct on the format of this method.

20. The fund raising method of claim 16 wherein the central database is a remotely accessible computer with an account for each independent contractor whereby each independent contractor can access and update his or her account and review payment status in a read-only format.
